(19) United States
(12) Patent Application Publication
(10) Pub. No.: US 2008/0247042 A1
(43) Pub. Date: Oct. 9, 2008

(54) Sweet Spot Beam Splitter for Separating Images

(75) Inventor: Armin Scwerdtner, Dresden (DE)

Correspondence Address: SYNNESTVEDT LECHNER & WOODBRIDGE LLP, P O BOX 592, 112 NASSAU STREET, PRINCETON, NJ, 08542-0592, US

(73) Assignee: SeeReal Technologies GmbH, Dresden (DE)

(21) Appl. No.: 10/570,035

(22) PCT Filed: Aug. 30, 2004
(86) PCT No.: PCT/DE2004/001911

§ 371 Date: Jun. 23, 2008

(30) Foreign Application Priority Data
Aug. 30, 2003 (DE) 103 40 089.3

(51) Int. Cl. G02B 27/10; G02B 27/22

(52) U.S. Cl. 359/463

(57) ABSTRACT

The invention relates to an optical imaging system for separating images, more specifically a sweet spot beam splitter, for an autostereoscopic display, which allows for greater freedom of movement of at least one observer in a lateral direction as well as regarding the distance from the display by expanding sweet spots up to and beyond the size corresponding to the distance between the eyes. The observer can move within said area without losing the 3D impression such that the demands on the positional accuracy and the reaction time of the tracking system are lowered. The inventive sweet spot beam splitter comprises a first lenticular system (L1) and a second lenticular system (L2), the strip-shaped lenses of which are disposed parallel to each other while being offset by half a lens width in a vertical direction relative to the columns of the image matrix (M). The distance therebetween preferably corresponds to the focal length of the second lenticular system (L2). The information-carrying columns of the image matrix (M) are reproduced at twice the width onto the strip lenses of the second lenticular (L2) by means of the first lenticular system (L1). The invention allows the user-friendliness of autostereoscopic displays to be substantially improved in many applications.

### CROSS REFERENCE TO RELATED APPLICATIONS

This application claims the priority of PCT/DE2004/001911 filed on Aug. 30, 2004, and DE 103 40 089.3 filed on Aug. 30, 2003, the entire contents of which are hereby incorporated in total by reference.

### BACKGROUND OF THE INVENTION

The present invention relates to an optical projection system for image separation in an autostereoscopic display which offers the viewers the possibility of greater mobility and which consists of two lenticulars with vertical strip lenses, which are arranged parallel to each other in the optical path, where the lenticulars are disposed behind an image matrix, seen in the direction of light propagation.

Autostereoscopic displays require left and right image information to be separated spatially through an optical projection system. Such optical projection systems are often referred to as beam splitters. The present invention relates to an autostereoscopic display with beam splitter and the representation of two views of a scene. Generally, in displays with two views a viewer can only perceive a cross-talking-free stereo image, if his eyes are precisely located at predetermined positions. These positions are also known in the literature as sweet spots.

If a fix barrier with a scanning ratio of 1:1 is used as a beam splitter, for example, each sweet spot is reduced to a point or, more precisely, a vertical line. If the viewer's eyes move away from those lines he will experience cross-talking. The right eye will see parts of the image which are intended for the left eye and vice versa. Similar disturbances are observed with other types of beam splitters, e.g. with a lenticular. Generally, cross-talking causes additional pseudoscopic images to be perceived which differ from the intended stereo images in so far as they are depth-inverted (see U.S. Pat. No. 6,055,013). These images already occur to a noticeable extent at a small lateral deviation of only 1 cm from the ideal sweet spot lines; they are not acceptable for good stereo viewing. In contrast, in monoscopic viewing cross-talking between the pixels is limited to colour errors or blurring, which are more likely to be tolerated by the viewer.

Because beam splitters typically consist of periodical structures, they create periodical recurrences of these sweet spots together with the periodical structures of the displays used (U.S. Pat. No. 5,991,073). If there are viewers at these positions, they can also perceive stereo images. Several manufacturers therefore call such displays multi-user displays. However, all viewers must exactly stick to their fixed positions, which are usually two eye distances apart. In the middle between these positions the scene would be perceived pseudoscopically. The fixed positions of the sweet spots are seen as a burden by the viewers.

Document [Börner, R. “Dreidimensional ohne Brille” in Funkschau, 2/1987, pp. 36-39] explains theoretical and practical findings of large-scale projection of 3D images in lens screens, which consist of a grid of cylinders.

With tracked autostereoscopic displays with beam splitter a viewer can move without losing the stereo impression. For this, the beam splitter is tracked according to the lateral movement of the viewer. The viewer's position is determined by a position detector. There are also autostereoscopic displays which determine in addition to the lateral movement the distance between viewer and display panel, and which track the beam splitter accordingly. This is achieved for example by changing the strip width of the parallax barrier (Perlin: WO 02/09442) or by dislocating the focusing system in relation to the image matrix (DE 198 36 681) or by tracking the illumination system (U.S. Pat. No. 6,014,164).

Detecting the viewer's position requires the same precision with point or line sweet spots as with untracked autostereoscopic displays. Further, in tracked autostereoscopic displays usually only one viewer can be tracked. If there are multiple viewers, they must all exactly follow the lateral movement of the tracked viewer,

Independent tracking of multiple viewers is described in patent WO 03/19952. The system disclosed in that patent consists of a double lenticular and a high-resolution shutter disposed in between. The description does not say anything about the extension of the sweet spots which can be achieved with that system.

Other major disadvantages of tracked autostereoscopic displays, which are mainly caused by the very small point or line sweet spots, are the great demands made on the precision of the position detection and on the precision of positioning the beam splitter. Further, cross-talking will always be perceived in the case of rapid viewer movements, because of the delay of position detector and tracking system.

EP 0 570 179 B1 describes an embodiment of an untracked autostereoscopic three-dimensional display. It comprises a spatial light modulator sandwiched between first and second lenticular screens. The pitch of the lenticules of the second screen is an integral multiple of that of the first screen. The spatial light modulator comprises a plurality of cells aligned with the lenticules of the first screen. A linear array of sequentially illuminated light sources is focused by an optical system into a plurality of collimated light beams with different angles of incidence on the first screen. For each illumination of the light sources, the spatial light modulator carries a plurality of 2D interlaced views.

### SUMMARY OF THE INVENTION

The above-mentioned drawbacks of tracked and untracked autostereoscopic displays with optical image separation systems for one or multiple viewers shall be overcome with the help of this invention.

It is therefore an object of this invention to provide an optical projection system for image separation for use in autostereoscopic displays, where the projection system is dimensioned and positioned such that it creates sufficiently large visibility regions in the form of extended sweet spots for at least one viewer. Further, a limited dimensioning ability of the projection system following the image matrix in the flat display shall be taken into account. Further, the sweet spot where the distance of a first lenticular from the image matrix is limited downwards shall be enlarged.

This objective is solved by the characterising features of the independent claim. Preferred embodiments of the invention are defined by the other claims.

The sweet spot beam splitter for image separation in an autostereoscopic display according to this invention is disposed behind an image matrix, seen in the direction of light propagation. It consists of a first lenticular and a second lenticular disposed behind the first one. The vertical strip lenses of the lenticulars are arranged parallel to each other and to the columns of the image matrix in the optical path. The image matrix contains in columns paired 3D image information for the left and right eye of a viewer.

According to the present invention, the distance between the lenticulars is about the focal length of the second lenticular, and the second lenticular is disposed at an offset of about half the strip lens width to the first lenticular. Further, the image information carrying columns of the matrix can be projected by the first lenticular on to the strip lenses of the second lenticular in doubled width, so that the bundles of rays which leave the second lenticular and which form the sweet spots consist of almost parallel rays.

These bundles of parallel rays represent the ideal case—in reality, the bundles of rays may as well be diverging or converging slightly. They generate in a viewing plane regions of cross-talking-free viewing with a lateral extension of at least the eye distance. Such a region covers the sweet spot of cross-talking-free stereoscopic viewing defined by the eye distance and an adjoining region which allows monoscopic, but cross-talking-free viewing. The sweet spot region preferably has the greatest possible width, which corresponds with the eye distance.

The above-mentioned parameters of the beam splitter according to the present invention—the distance between the lenticulars in the range of the focal length of the second lenticular, the offset of the second lenticular in respect to the first one of about half the width of the strip lenses and the projection of the image information carrying columns of the matrix through the first lenticular at doubled width on to the strip lenses of the second lenticular—are preferred, advantageous and optimised parameters. However, in particular in the context of continuous diminution of the pixel size, these parameters may be subject to considerable fluctuations due to fabrication tolerances, warping through the effects of heat etc.

Thanks to the enlargement of the sweet spots with the help of the image separation system according to this invention, a number of disadvantages of autostereoscopic displays are remedied at the same time. A viewer can move laterally in a sweet spot in the viewing space without losing the 3D impression. The corresponding mobility range is limited to one eye distance. It is thus sensible to choose a sweet spot extension of an eye distance of a viewer, i.e. about 65 mm. However, larger sweet spots are possible. They perform as well as long as the sweet spots for the right and left eye do not overlap.

With untracked autostereoscopic displays, lateral and normal movements, i.e. movements which affect the distance between viewer and display, are thus preferably possible in a sweet spot without the occurrence of cross-talking, e.g. pseudoscopic effects, due to the changed position of the viewer. This also improves the ability of untracked displays to support multiple users.

According to the invention, the focussing of the sweet-spots in the image-plane will be supported. In a further embodiment of the invention a field-lens or a combination of field-lenses is arranged following the second lenticular with respect of the direction of light propagation. A field lens can be a spherical or cylindrical or for example a combination of two crossed cylindrical field-lenses.

In a preferred embodiment the field-lens is cylindrical and it is arranged parallel to the strip-lenses of the lenticulars. Preferable, the pitch of the field-lens is incommensurable to the pitch of the image-matrix so that there is no zone within the viewing-region where a viewer can actually see multiple projections through the strip-lenses of lower optical quality simultaneously. An incommensurable ratio of pitches can be interpreted as the fraction of two prime numbers.

In a preferred embodiment the structured surface of a field lens is facing the lenticular and its planar surface is coated forming the cover panel of the display. The field-lens can also be a holographic optical element.

Thanks to the enlargement of the sweet spots, the great demands on the precision of the positioning of the sweet spot beam splitter depending on the viewer's position can be substantially reduced in tracked displays. This also reduces the demands made on the precision of the position detector and on the delay of the tracking system. Changes in the position of the viewer within a sweet spot are tolerated without any quality impairment of the 3D representation. In addition to a reduction of the lateral positioning sensitivity of the sweet spot beam splitter, the demands made on the precision of the distance between viewer and display are reduced as well. The viewer now has a certain mobility range as regards his distance to the display. He can move in a rhombic space without the risk of cross-talking. Another positive effect concerns the delay of the tracking system. It can be increased without any adverse effects on the 3D image quality.

These and other features of the invention will be more fully understood by reference to the following drawings.

### BRIEF DESCRIPTION OF THE DRAWINGS

FIG. 1 is a schematic diagram which illustrates the prior art image projection in an untracked autostereoscopic display with image matrix and conventional beam splitter.

FIG. 2 is a schematic diagram which illustrates the prior art image projection similar to FIG. 1, where the viewer has changed his lateral position.

FIG. 3 is a schematic diagram which illustrates the image projection in an untracked autostereoscopic display with image matrix and sweet spot beam splitter according to the present invention.

FIG. 4 is a schematic diagram which illustrates the image projection similar to FIG. 3, where the viewer has changed his lateral position.

FIG. 5 is a schematic diagram which illustrates the generation of a sweet spot for the two eyes of a viewer with a beam splitter according to this invention.

FIG. 6 is a schematic diagram which illustrates the extension of a sweet spot for the right eye of a viewer with a beam splitter according to this invention.

FIG. 7 is a schematic diagram which shows the sweet spot regions which define where a viewer can move without losing the stereo impression.

FIG. 8 is a schematic diagram which illustrates another embodiment of the beam splitter according to this invention with reduced pitches.

FIG. 9 is a schematic diagram which shows the arrangement of the lenticulars L1 and L2 to form a compact element.

FIG. 10 is a schematic diagram which shows another embodiment of the invention.

FIG. 11 is a schematic diagram which shows another variant of the embodiment of the invention shown in FIG. 9.

FIG. 12 is an embodiment of the invention including a field-lens

All diagrams are top views.

### DETAILED DESCRIPTION OF THE INVENTION

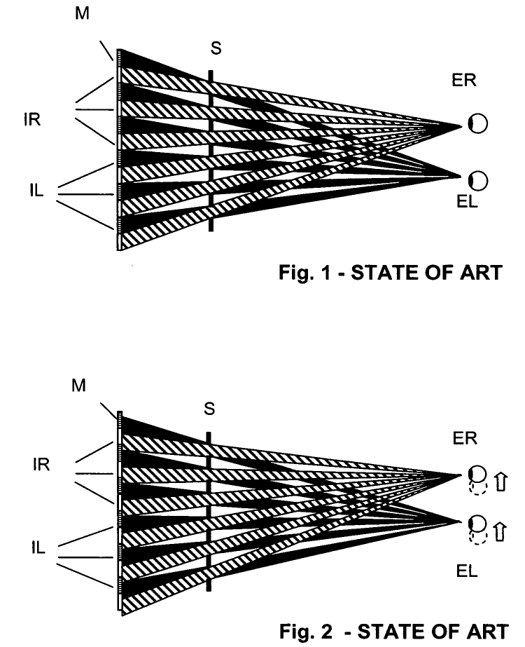

FIGS. 1 and 2 illustrate schematically the prior art image projection in an untracked autostereoscopic display with image matrix and conventional beam splitter. FIG. 1 is a schematic diagram which illustrates the prior art image projection in an untracked autostereoscopic display with image matrix and conventional beam splitter.

Seen in the direction of light propagation, FIG. 1 shows one after another an image matrix M, a conventional beam splitter S and the left eye EL and the right eye ER of a viewer. The image matrix M contains a right and a left stereo image IR and IL, which are interleaved alternately in columns. The sweet spot which carries the image information only has the extension of a point or vertical line. If the viewer's eyes are precisely in these sweet spots, he will perceive a stereo image without cross-talking. The right eye can only see the right stereo image, and the left eye can only see the left stereo image.

FIG. 2 is a schematic diagram which illustrates the prior art image projection similar to FIG. 1, where the viewer has changed his lateral position. Compared with FIG. 1, the viewer has moved to the right a little, the former eye position is shown by dotted lines. He now additionally perceives part of the left stereo image IL with his right eye ER and part of the right stereo image IR with his left eye EL. This results in a pseudoscopic 3D representation, where the depth impression is inverted. The pseudoscopic image overlaps the remaining, weakened stereo image. It will thus be perceived much clearer than cross-talking of pixels in the 2D mode.

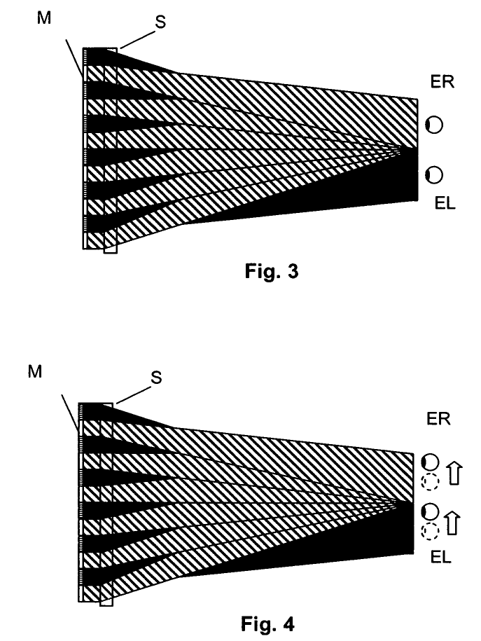

The two FIGS. 3 and 4 illustrate the image projection in an autostereoscopic display with a beam splitter according to the present invention. FIG. 3 is a schematic diagram which illustrates the image projection in an untracked autostereoscopic display with image matrix and sweet spot beam splitter according to the present invention. The image matrix M is followed by a sweet spot beam splitter S according to this invention, which laterally expands the sweet spots in the regions of the two viewer's eyes in comparison with a conventional beam splitter.

FIG. 4 is a schematic diagram which illustrates the image projection similar to FIG. 3, where the viewer has changed his lateral position. The arrows show that the viewer has moved to the right a little, but without leaving the sweet spots, and thus without losing the stereo impression. He can as well move to the left by the same distance. Thanks to the expanded sweet spot regions created by the beam splitter according to this invention, the viewer is not restricted to inconveniently keeping a fixed position.

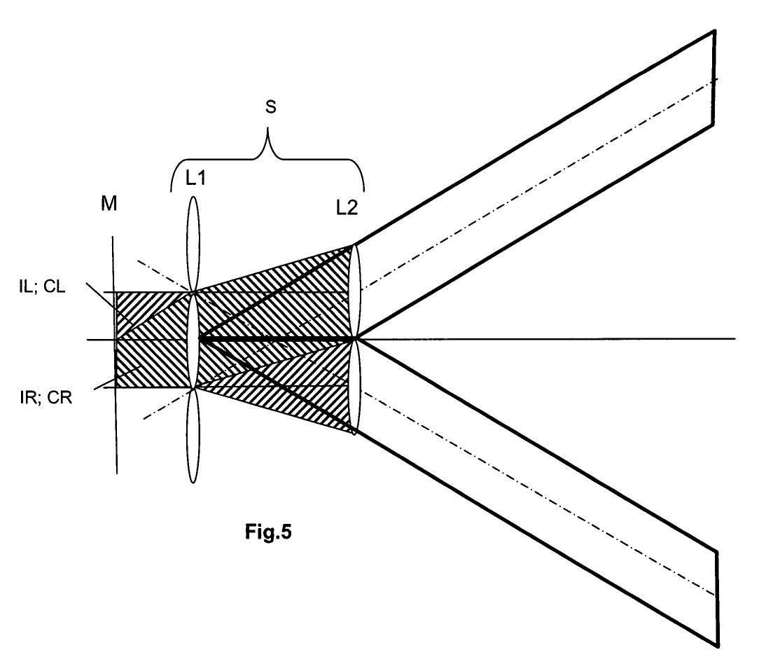

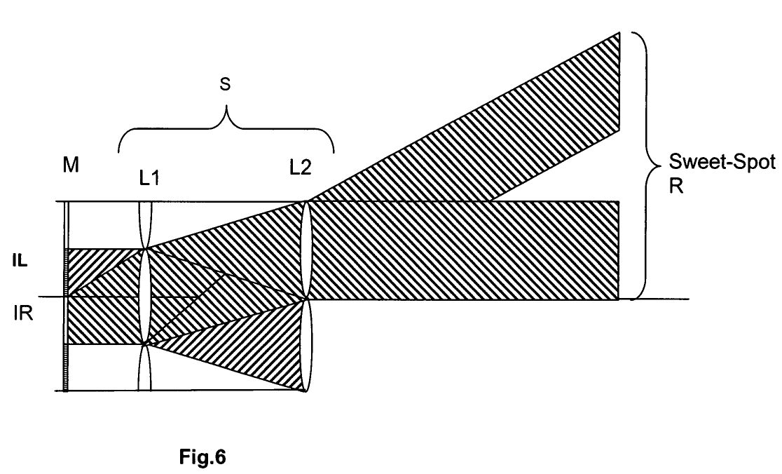

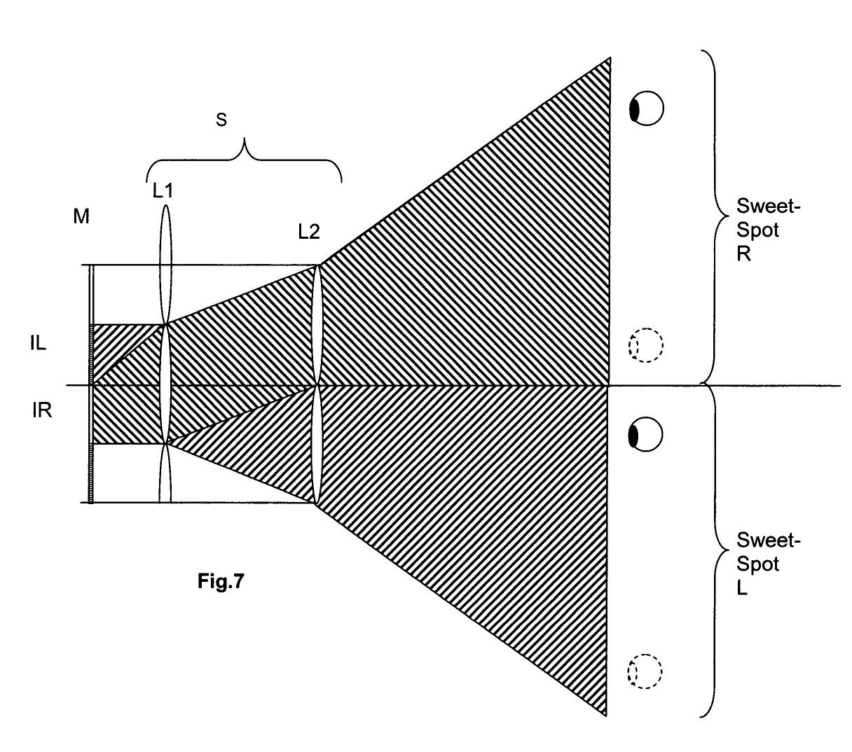

FIG. 5 is a schematic diagram which illustrates the generation of a sweet spot for the two eyes of a viewer with a beam splitter according to this invention. The sweet spot beam splitter S according to this invention is shown in more detail in this Figure. It is disposed between the viewer and the image matrix M. The image matrix M contains in columns paired 3D image information for the left and right eye of a viewer.

The sweet spot beam splitter S consists of two lenticulars L1 and L2. The distance between the two lenticulars is about the focal length of the second lenticular L2. The vertical strip lenses of the two lenticulars, L1 and L2, are arranged parallel to each other in the optical path. Further, the lenticulars L1 and L2 are offset by about half a pitch, i.e. half the width of the strip lenses. The right and left columns of the image matrix M are projected by the first lenticular L1 entirely on to the corresponding lenses of the second lenticular L2.

One lens element of the lenticular L2 is entirely filled with the image of the corresponding column of the image matrix M. In this preferred embodiment the strip lenses of the lenticulars L1 and L2 thus have the width of two pixel or column widths, whereby each strip lens of the lenticular L1 covers two pixel columns of the image matrix M in this Figure and in the two following Figures. The bundles of rays preferably leave the lenticular L2 almost parallel, which is shown by the bold lines in the Figure.

The characteristics of the beam splitter according to the present invention—the distance between the lenticulars in the range of the focal length of the second lenticular, the offset of the second lenticular in respect to the first one of about half the width of the strip lenses and the projection of the image information carrying columns of the matrix through the first lenticular at doubled width on to the strip lenses of the second lenticular—can generally be considered to be a second-order system. However, the idea of this invention is also maintained with higher-order systems or mixed forms.

FIG. 6 shows a sweet spot beam splitter arrangement similar to that in FIG. 5, which illustrates the generation of a sweet spot for the right eye of a viewer. A right information-carrying column CR with the right image IR is projected by the first lenticular L1 on to the second lenticular L2 and leaves the second lenticular L2 as a bundle of almost parallel rays towards the right viewer's eye. The bundle of parallel rays represents the ideal case—in reality, the bundle of rays may as well be diverging or converging slightly. Each point of a column in the lenticular L1 has the same image content. Each parallel ray, which can be assigned to a corresponding column and which leaves the lenticular L2, thus carries its content.

FIG. 7 is a schematic diagram which shows the sweet spot regions which define where a viewer can move without losing the stereo impression. It shows the regions which are covered by the sweet spots for the two eyes of the viewer thanks to the use of the sweet spot beam splitter S according to this invention. The dotted eyes ER and EL of the viewers demonstrate how far he can move without leaving the region of stereo viewing. A sweet spot region in the viewing plane which is larger than the eye distance consists of the region of cross-talking-free stereoscopic viewing as defined by the eye distance and an adjoining region which allows monoscopic but cross-talking-free viewing.

In FIGS. 5 to 7, the pitches of the lenticulars L1 and L2 are identical and twice as great as the pitch of the image matrix M. According to this invention, the lenticulars L1 and L2 of the sweet spot beam splitter S can be combined with other optical means, e.g. with a field lens. In a continuation of this invention, the pitch of the lenticulars L1 and/or L2 may be modified.

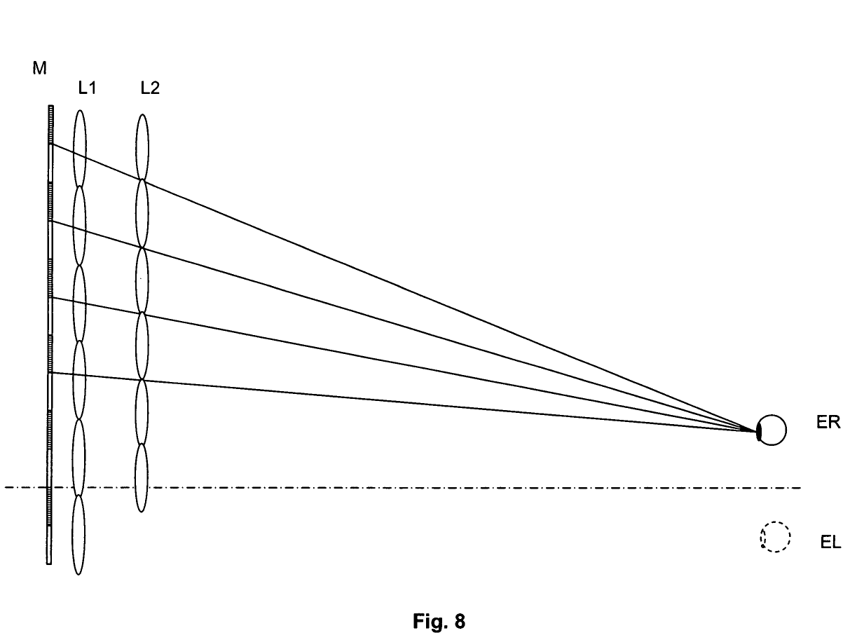

FIG. 8 shows a sweet spot beam splitter S according to this invention with the pitches of the lenticulars decreased such to cause a field lens effect. More precisely, starting from the image matrix M, the pitches of the lenticulars L1 and L2 are decreased in proportion to their distance to the viewer, as can be seen in the Figure.

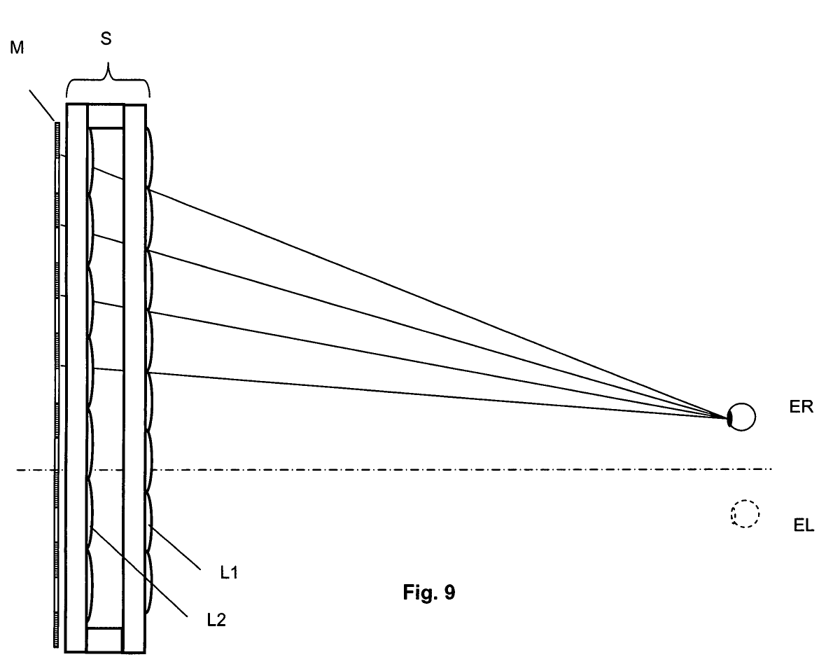

FIG. 9 shows a combination of the lenticulars L1 and L2 of the sweet spot beam splitter S to form a compact element. The two substrates which carry the lenticulars are fixedly joined, i.e. by gluing. This has the advantage of providing the possibility of an independent alignment of the two lenticulars and of reducing the number of single optical elements.

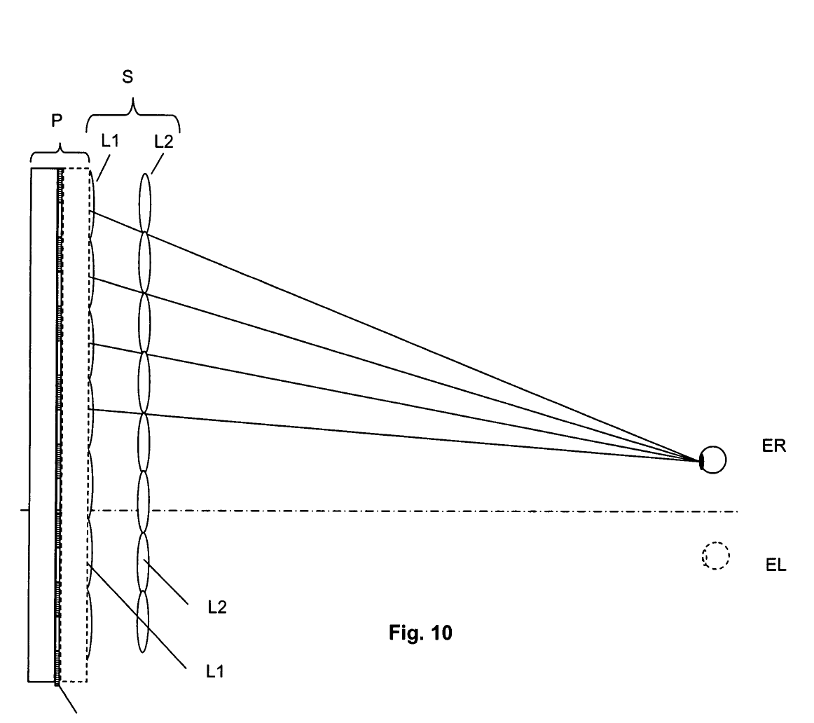

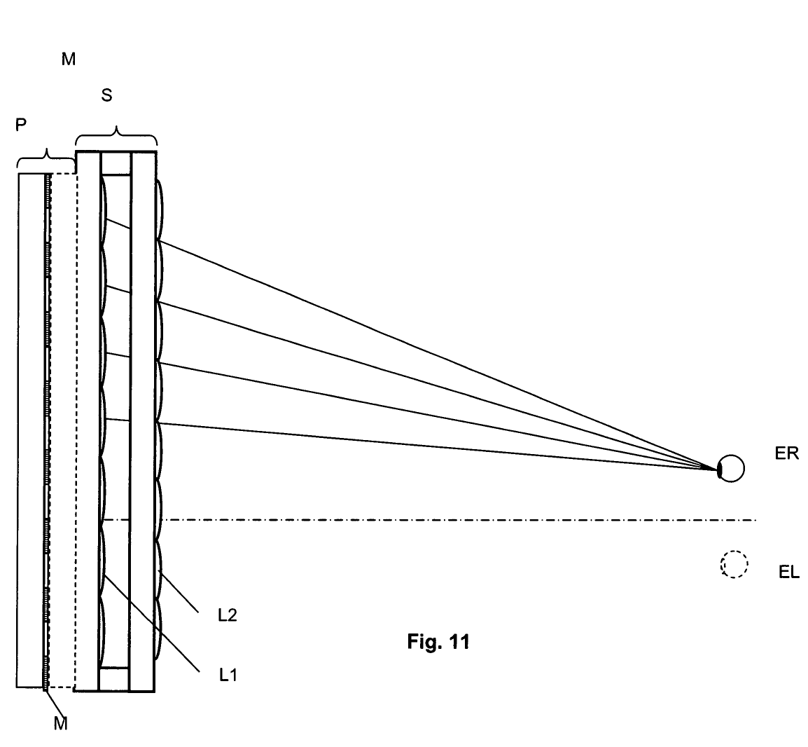

FIG. 10 shows another embodiment of the invention. The lenticular L1 of the sweet spot beam splitter is attached directly to the glass panel P of the image matrix M. This design has the advantage that there is one reflecting face less.

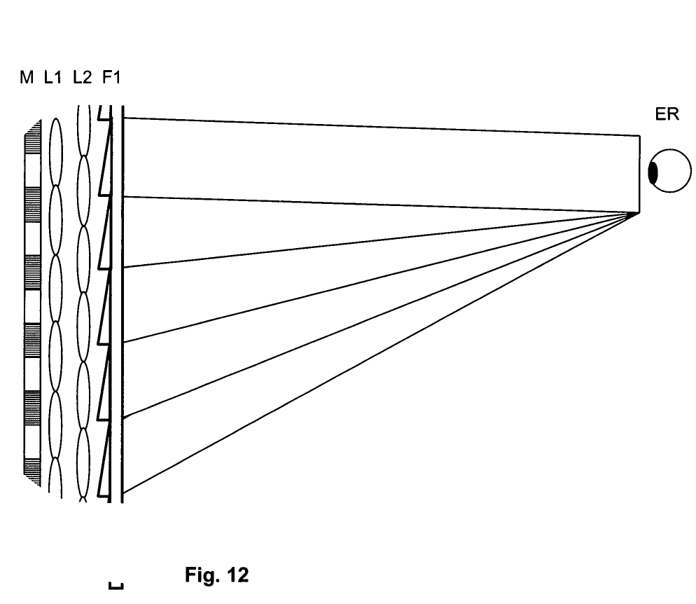

According to another variant of the invention, shown in FIG. 11, the entire compact beam splitter unit S of FIG. 9 is attached directly to the panel P. This may be done by gluing or any other suitable joining method which creates a fixed connection. This also reduces the number of optical elements used and the number of reflecting faces.

FIG. 12 shows an embodiment of the sweet spot beam splitter including a field-lens F1. In this preferred embodiment the field-lens F1 is a cylindrical Fresnel-lens. It is arranged parallel to the strip-lenses of the lenticulars L1 and L2. The pitches of the lenticulars L1 and L2 are equal, but, as shown in this figure, the pitch of the field-lens is incommensurable to the pitch of the image-matrix. In this case, the incommensurable pitch will be the ratio of the prime numbers 13 and 17. According to this embodiment there are no zones within the viewing-region where a user can see multiple error-prone and low-quality image-generations through a strip-lens simultaneously.

Finally, the structured surface of the field-lens F1 is facing the lenticular L2 and its planar outer surface is coated forming the cover of the panel. In this embodiment the second lenticular L2 and the field lens F1 are attached to form a one-piece unit, which also could include the first lenticular L1.

Thanks to the enlargement of the sweet spots with the help of the inventive means, autostereoscopic display applications become more user-friendly. These displays may be used for multi-media applications, 3D TV, CAD and military purposes, games, mobile phones, palmtops and other applications not specified here.

While the invention has been described with reference to the preferred embodiment thereof it will be appreciated by those of ordinary skill in the art that modifications can be made to the parts that comprise the invention without departing from the spirit and scope thereof.

1. Sweet spot beam splitter for image separation for use in an autostereoscopic display, comprising an image matrix (M), containing in columns (CR,CL) paired image information for the left and right eye of a viewer, a first lenticular (L1) and a second lenticular (L2), said elements being disposed in the direction of light propagation, where the strip lenses of the lenticulars are arranged vertical and parallel to each other and to the columns of the image matrix (M), characterised in that the width the strip lenses of lenticulars (L1) and (L2) are equal, the distance between the lenticulars (L1) and (L2) is about identical to the focal length of the second lenticular (L2); the lenticular (L2) is disposed at an offset to the first lenticular (L1) of about half the width of the strip lenses; and said lenticulars are dimensioned and positioned such that the image information carrying columns of the image matrix are projected by the first lenticular (L1) on to the strip lenses of the second lenticular (L2) in doubled width and that the bundles of rays which leave the second lenticular (L2) consist of almost parallel rays, generating sweet spots in a viewing plane with a lateral extension of at least the eye distance.

2. Sweet spot beam splitter according to claim 1, in which the lenticulars (L1) and (L2) are attached to form a one-piece unit.

3. Sweet spot beam splitter according to claim 1, in which the lenticulars (L1) and (L2) are attached to the same substrate.

4. Sweet spot beam splitter according to claim 1, in which the first lenticular (L1) is attached directly to the glass panel of the image matrix (M).

5. Sweet spot beam splitter according to claim 2, in which the one-piece unit of lenticulars (L1) and (L2) is fixedly joined to the glass panel of the image matrix (M).

6. Sweet spot beam splitter according to claim 1, in which a field lens (F1) or a combination of field lenses is arranged following the second lenticular (L2).

7. Sweet spot beam splitter according to claim 6, the field lens (F1) or the combination of field lenses being spherical or cylindrical.

8. Sweet spot beam splitter according to claim 7, the field lens being a combination of two crossed cylindrical field lenses.

9. Sweet spot beam splitter according to claim 6, one or more field lenses being a Fresnel-lens.

10. Sweet spot beam splitter according to claim 6, the pitch of one or more field lenses being incommensurable to the pitch of the image matrix (M).

11. Sweet spot beam splitter according to claim 10, the pitch of one or more field lenses being incommensurable and the ratio of the pitches being characterized by the fraction of two prime numbers.

12. Sweet spot beam splitter according to claim 11, in which one or more field lenses (F1) are cylindrical and are arranged parallel to the strip lenses of the lenticulars (L1, L2), the pitch of one or more field lenses being incommensurable to the pitch of the image matrix (M).

13. Sweet spot beam splitter according to claim 6, the field lens or the combination of field lenses being holographic optical elements.

14. Sweet spot beam splitter according to claim 1, in which the structured surface of a field lens (F1) is facing the lenticular (L2) and its planar surface is coated forming the cover panel of the display.

15. Sweet spot beam splitter according to claim 1, in which the lenticular (L2) and the field lens (F1) are attached to form a one-piece unit.
